(19) United States
(12) Patent Application Publication
(10) Pub. No.: US 2024/0303048 A1
(43) Pub. Date: Sep. 12, 2024

(54) SYSTEMS AND METHODS FOR IMPLEMENTING HOMOICONIC REPRESENTATIONS OF CLIENT-SPECIFIC DATASETS

(71) Applicant: WEALTHCOUNSEL PROPERTIES, LLC, Salt Lake City, UT (US)

(72) Inventor: Stewart E. SHELLINE, Salt Lake City, UT (US)

(21) Appl. No.: 18/552,419

(22) PCT Filed: Mar. 24, 2022
(86) PCT No.: PCT/US2022/021753

§ 371 Date: Sep. 25, 2023

Related U.S. Application Data
(60) Provisional application No. 63/166,092, filed on Mar. 25, 2021.

(51) Int. Cl. G06F 8/34; G06F 8/51; G06F 40/186; G06F 40/221

(52) U.S. Cl. CPC G06F 8/34; G06F 8/51; G06F 40/186; G06F 40/221

(57) ABSTRACT

A system for implementing homoiconic representations of client-specific datasets receives a client-specific dataset. The client-specific dataset is interpretable to facilitate one or more end use operations. The client-specific dataset comprises at least (i) a first set of interpretable code, the first set of interpretable code comprising one or more first computer-interpretable languages and (ii) a second set of interpretable code, the second set of interpretable code comprising one or more second computer-interpretable languages. The system generates a homoiconic representation of the client-specific dataset. The homoiconic representation comprises a single syntax for depicting logic components, content components, and structural components. The single syntax is different than syntaxes associated with the one or more first computer-interpretable languages and the one or more second computer-interpretable languages.

### CROSS-REFERENCE TO RELATED APPLICATIONS

This application claims priority to U.S. Provisional Application No. 63/166,092, filed Mar. 25, 2021 and entitled “SYSTEM FOR THE GENERATION OF DYNAMIC DOCUMENTS”, and U.S. Provisional Application No. 63/166,099, filed Mar. 25, 2021 and entitled “SYSTEM FOR DYNAMIC UPDATING OF AN EXTENSIBLE GLOBAL PREDEFINED DATA MODEL”, which are incorporated herein by reference.

### BACKGROUND

Computers and computing systems have affected nearly every aspect of modern living. Computers are generally involved in work, recreation, healthcare, transportation, entertainment, household management, etc. For example, computers have found significant use within the legal field in relation to the creation, editing, and processing of documents. Historically, many legal documents were created using typewriters that by their nature are not dynamic. Typically, typewriters required laborious manual typing of each letter in the document and the manual management of document formatting.

With the advancement of digital word processors, it became far easier to edit legal documents and to reuse portions of previous legal documents. Additionally, various software tools were created for attorneys that allowed the attorneys to utilize variables within a document. For example, a user could enter a name within a field and that name would be populated throughout the legal document.

While these advancements have been beneficial to the creation of dynamic documents, including in the legal field, they leave a great deal to be desired with respect to the generation, modification, and/or updating of dynamic legal documents.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least one embodiment comprises a system that includes one or more processors and one or more hardware storage devices that store instructions that are executable by the one or more processors to configure the system to perform various acts. The acts include receiving a client-specific dataset. The client-specific dataset is interpretable to facilitate one or more end use operations. The client-specific dataset comprises at least (i) a first set of interpretable code, the first set of interpretable code comprising one or more first computer-interpretable languages and (ii) a second set of interpretable code, the second set of interpretable code comprising one or more second computer-interpretable languages that are different from the one or more first computer-interpretable languages. The acts further include generating a homoiconic representation of the client-specific dataset. The homoiconic representation comprises a single syntax for depicting logic components, content components, and structural components. The single syntax is different than syntaxes associated with the one or more first computer-interpretable languages and the one or more second computer-interpretable languages.

At least one embodiment comprises a system that includes one or more processors and one or more hardware storage devices that store instructions that are executable by the one or more processors to configure the system to perform various acts. The acts include receiving a homoiconic representation of a client-specific dataset. The homoiconic representation comprises a single syntax for depicting logic components, content components, and structural components associated with the client-specific dataset that defines one or more end use operations. The acts further include generating a runtime representation using the homoiconic representation of the client-specific dataset. The runtime representation is interpretable to facilitate the one or more end use operations. The runtime representation comprises at least (i) a first set of interpretable code, the first set of interpretable code comprising one or more first computer-interpretable languages and (ii) a second set of interpretable code, the second set of interpretable code comprising one or more second computer-interpretable languages that are different from the one or more first computer-interpretable languages. Syntaxes associated with the one or more first computer-interpretable languages and the one or more second computer-interpretable languages are different than the single syntax.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1A illustrates an example representation of a portion of a client-specific dataset, in accordance with implementations of the present disclosure.

FIG. 1B illustrates an example representation of another portion of a client-specific dataset, in accordance with implementations of the present disclosure.

FIG. 2A illustrates an example representation of an end user operation associated with the client-specific dataset of FIGS. 1A and 1B, in accordance with implementations of the present disclosure.

FIG. 2B illustrates an example representation of another end user operation associated with the client-specific dataset of FIGS. 1A and 1B, in accordance with implementations of the present disclosure.

FIG. 2C illustrates an example representation of another end user operation associated with the client-specific dataset of FIGS. 1A and 1B, in accordance with implementations of the present disclosure.

FIG. 3 illustrates a conceptual depiction of generating a homoiconic representation of a client-specific dataset, in accordance with implementations of the present disclosure.

FIG. 4A illustrates an example homoiconic representation of a client-specific dataset, in accordance with implementations of the present disclosure.

FIG. 4B illustrates an example of structural components depicted in a homoiconic representation of a client-specific dataset, in accordance with implementations of the present disclosure.

FIGS. 4C and 4D illustrate examples of content components depicted in a homoiconic representation of a client-specific dataset, in accordance with implementations of the present disclosure.

FIG. 4E illustrates an example of logic components depicted in a homoiconic representation of a client-specific dataset, in accordance with implementations of the present disclosure.

FIG. 5 illustrates a conceptual depiction of generating a runtime representation based upon a homoiconic representation of a client-specific dataset, in accordance with implementations of the present disclosure.

FIGS. 6A, 6B, and 6C illustrate example operations associated with a recursive descent transform, in accordance with implementations of the present disclosure.

FIG. 7 illustrates a conceptual depiction of generating a report based upon updates and client modifications to a base body of code, in accordance with implementations of the present disclosure.

FIG. 8 illustrates an example flow diagram depicting acts associated with generating a homoiconic representation of a client-specific dataset, in accordance with implementations of the present disclosure.

FIG. 9 illustrates an example flow diagram depicting acts associated with generating a runtime representation of a homoiconic representation of a client-specific dataset, in accordance with implementations of the present disclosure.

FIGS. 10 and 11 illustrate example flow diagrams depicting acts associated with generating reports based upon updates and client modifications to a base body of code, in accordance with implementations of the present disclosure.

### DETAILED DESCRIPTION

Disclosed embodiments are directed towards an innovative system and method for generating dynamic documents.

In at least one embodiment, disclosed systems for generating dynamic documents may be utilized within the legal field of estate planning. The domain of estate planning contains a number of objects, including: people, organizations, assets, liabilities, jurisdictions, roles, events, etc. The interplay of these objects within a document—the logic, grammar, and structure of a trust, for example—can be difficult to accurately express and validate because it requires the combination of a programming language (for logic, looping, and variable text) with the grammar, structure, and presentation of a legal instrument. For non-trivial legal expressions, this results in a hard-to-understand and maintain combination of code and text that is difficult to examine and difficult to test for quality assurance.

Disclosed embodiments combine the logic, language, and structure of a complex legal expression into a single syntax, or homoiconic, domain-specific language. In some instances, this language may be formed as an XML document and can be:
Validated for well-formedness, adherence to a data model, and compliance with business rules using common tools such as XML Schema Definition language (XSD), RelaxNG, and Schematron.
Processed or transformed using most modern computer programming languages as well as XML-specific languages like XQuery and XSLT.
Stored in XML databases, where it can be queried and updated using common languages such as SQL and XQuery.
Shared easily with third parties in its native format.

In at least one embodiment, a system for generation of dynamic documents comprises one or more processors and one or more computer-readable media (e.g., one or more hardware storage devices) having stored thereon executable instructions that are executable by the one or more processors to configure the system to perform operations associated with dynamically generating documents. A dynamically generated document may comprise a digital document that automatically generates at least a portion of the text that the document contains.

The text for a dynamic document (and/or the presentation of such text) may be determined based upon a client-specific dataset that includes client-defined entries, preferences, content, structure, logic, etc. A client-specific dataset may comprise interpretable code that is executable to facilitate one or more end use operations (e.g., presentation of a dynamic document, presentation of an interactable workflow, etc.). For example, in the domain of estate planning, a client may comprise a legal services enterprise (e.g., a law firm), and the client-specific dataset may comprise executable code for at least (i) facilitating user input acquisition workflows (e.g., interviews) for receiving estate planning information for individuals and (ii) generating dynamic documents or templates (e.g., estate planning documents, such as a trust, will, healthcare directive, etc.) based upon the received estate planning information. In some instances, the interpretable code of a client-specific dataset includes code in multiple languages (e.g., markup languages, programming languages, etc.).

A server may receive one or more client-specific datasets (e.g., as part of a cloud service or architecture that services multiple clients). One or more processors may generate homoiconic representations of the client-specific datasets for storage at the server. The homoiconic representations of the client-specific datasets comprise code-agnostic representations of the client-specific datasets that depict structure, content, and logic with a single syntax. The homoiconic representations are transformable into runtime representations for use in runtime environments. In this way, end use operations based upon client-specific datasets may be generated on demand and/or for various runtime environments, even where such runtime environments utilize executable code of multiple languages. Such functionality allows clients to define/build a client-specific dataset in/for various runtime environments (which may involve multiple coding languages), while still allowing a server to store a code-agnostic form of the client-specific dataset.

Furthermore, as will be described in more detail hereinafter, such functionality also allows for management of client modifications to template code/documents, as well as independent updates to such template code/documents. For example, a client (e.g., a legal services enterprise) may modify or delete particular paragraphs of template code for generating an estate planning document. A central entity that provides the developer tools to the client for generating estate planning forms/documents may independently update the same paragraphs (e.g., utilizing a homoiconic representation of the base code). Such updates may occur, for example, based upon evolving case law, regulations, legislation, best practices, etc. in the domain of estate planning. The central entity may generate a report and provide it to the client when the client has modified or deleted paragraphs that have also been updated by the central entity. Such functionality may allow for updating of base code/templates in a manner that allows clients to preserve their client-specific modifications/preferences.

Although the examples and disclosure provided herein focus, in at least some respects, on the domain of estate planning, the principles disclosed herein may be applied within any other domain(s).

### Techniques for Implementing Homoiconic Representations of Client-Specific Datasets

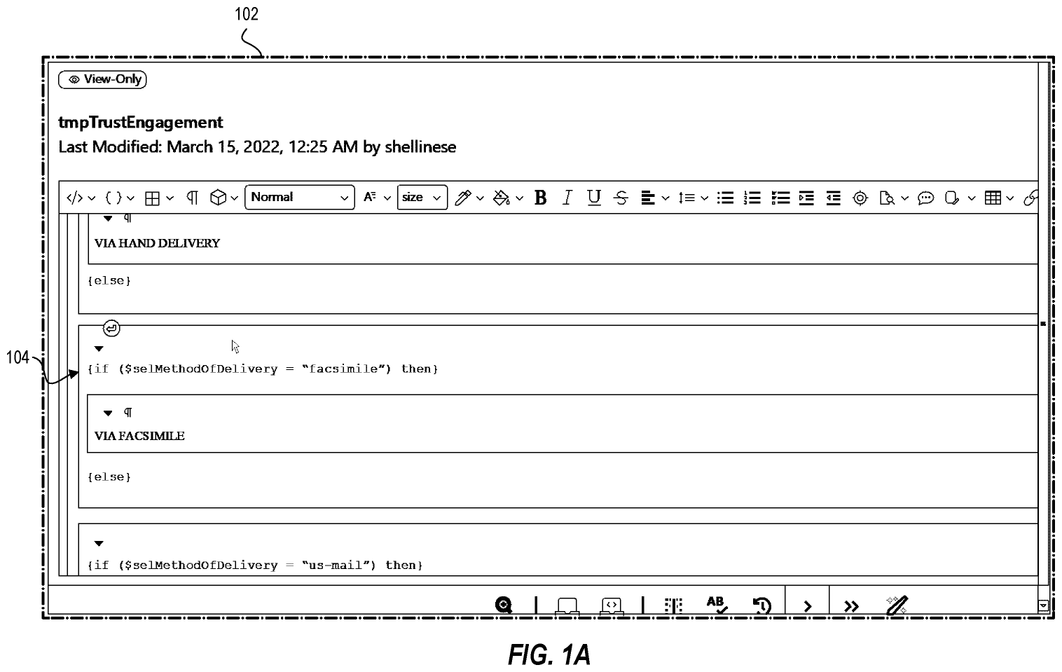

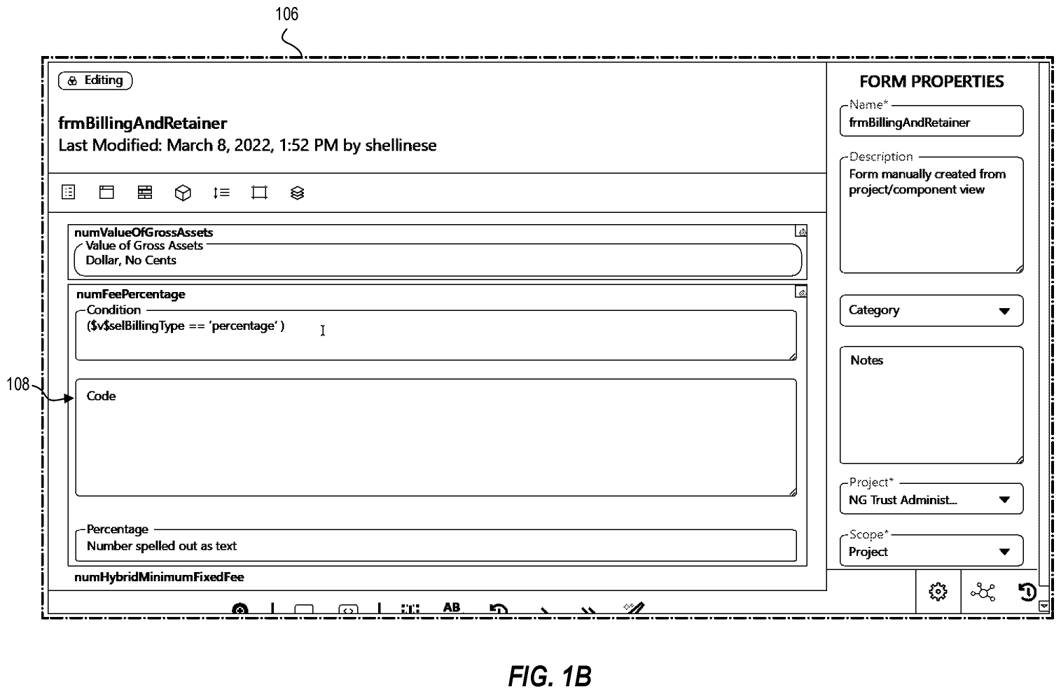

FIG. 1A illustrates an example representation of a portion of a client-specific dataset. In particular, FIG. 1A shows a client interface 102 of a developer tool for facilitating generation of dynamic documents within the domain of estate planning. The developer tool may be utilized by any user or entity (referred to herein as a “client”), such as by a legal services enterprise. A central entity may provide the client with access to the developer tool in the context of a cloud service, allowing the developer tool to be accessed from different client devices and/or environments.

The developer tool may be configured to allow clients to define preferences (e.g., formatting, content, logic, etc.) related to end use operations. For example, end use operations may include inputting or receiving estate planning information for individuals and generating estate planning documents based upon the information. The client interface 102 of FIG. 1A includes an editor interface that allows clients to define preferences related to generating a template for a trust engagement document (“tmpTrustEngagement”). The client may define their preferences related to generation of the trust engagement document using interpretable code. For instance, FIG. 1A provides the example client interface 102, which includes XQuery code 104, indicating output text “VIA FACSIMILE” that can be applied to the generated trust engagement document if method of delivery indicated as selected at runtime is “facsimile”.

FIG. 1B illustrates a client interface 106 (e.g., accessible via the same developer tool associated with client interface 102 of FIG. 1B) associated with generating an interactive form or workflow for receiving billing and retainer information (“frmBillingAndRetainer”). The received information may be used to generate an output estate planning document or template, such as the trust engagement document noted above with reference to FIG. 1A. The client may define their preferences related to the interactive form or workflow utilizing interpretable code. For instance, FIG. 1B provides the example client interface 106, which includes JavaScript code 108 indicating a condition for utilizing a percentage fee billing structure, which may be applied to generate the objects for the form or workflow for receiving billing and retainer information.

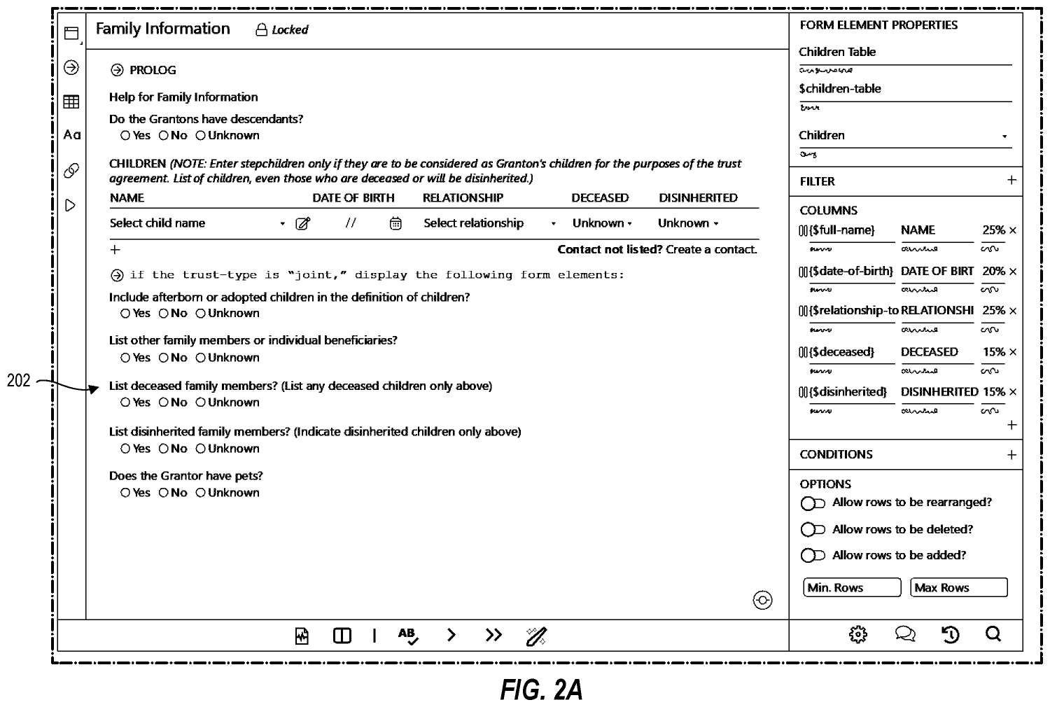

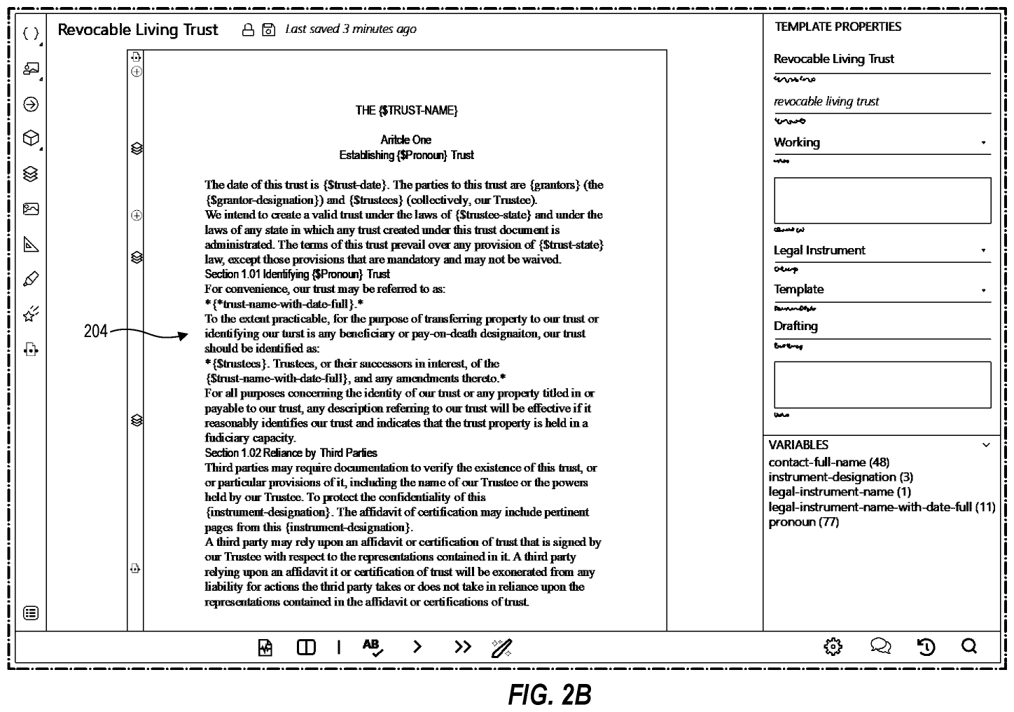

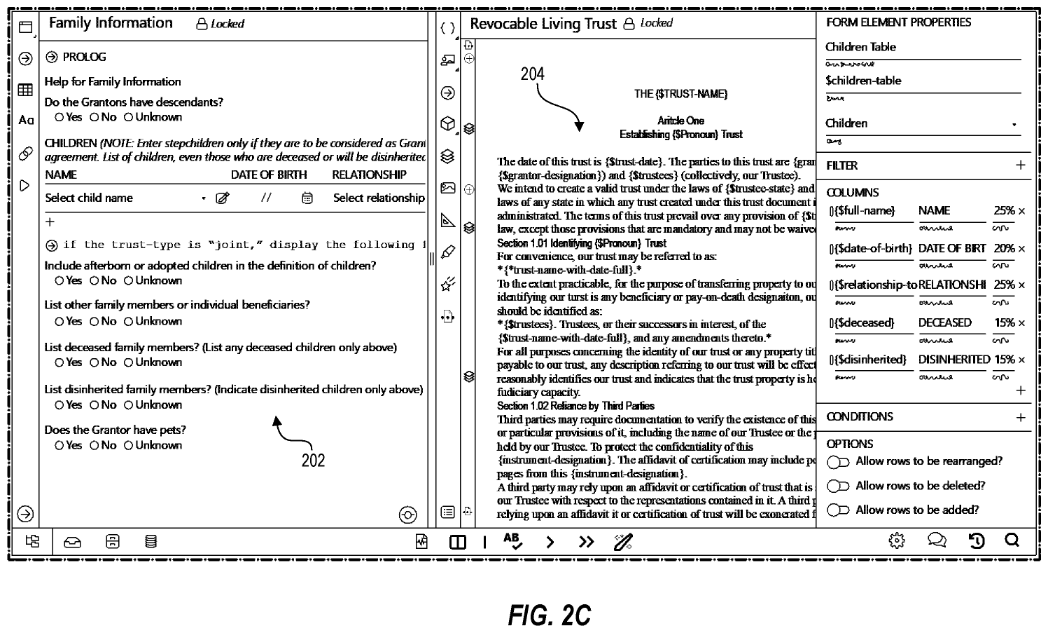

A client-specific dataset may capture the client preferences indicated within a developer tool, such as those shown and described with reference to the examples of FIGS. 1A and 1B. As noted above, such client preferences (e.g., commands, formatting, content, etc.) may relate to various end use operations, such as generation of documents, templates, interactable forms, etc. For instance, FIG. 2A illustrates example interactable content 202 that may be generated based upon interpretation of a client-specific dataset. The interactable content 202 may be configured to facilitate user input acquisition operations, such as to acquire information for generating estate planning documents. In some instances, the user input acquisition is constrained by a predefined data model, which may impose domain-specific constraints on the received user input to ensure validity and/or quality of the input information. For example, a predefined data model may require selection from among predefined values (as shown in FIG. 2A). In some instances, where text input is received, the predefined data model may require numerical values to be entered for ages, entity types to be entered for non-human legal entities, coherence of relationship information, coherence of defined roles, etc.

FIG. 2B illustrates an example template 204 that may be generated based upon interpretation of a client-specific dataset (e.g., utilizing information acquired using interactable content 202). The template 204 may comprise an estate planning document, such as a revocable living trust. FIG. 2C illustrates the interactable content 202 and the example template 204 displayed simultaneously within a client interface to facilitate further client modification of the client-specific dataset (e.g., to allow clients to identify errors in their client-specific dataset and/or to visualize interpretation of their client-specific dataset). A client-specific dataset may thus be deployed or interpreted in a testing environment or quality assurance environment to ensure proper functioning and/or display in preparation for production. In some implementations, the client-defined preferences of a client-specific dataset may be constrained according to a predefined schema, which may facilitate real-time validation of client entries within the developer tool. For instance, clients may be automatically alerted, in real time, to syntactical errors with entry of executable code within the developer tool.

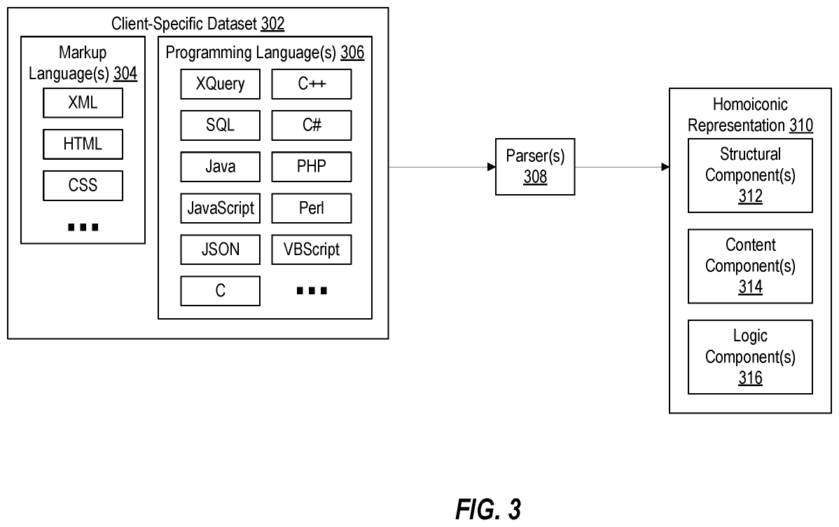

In view of the foregoing, a client-specific dataset may comprise interpretable code that is interpretable to facilitate such end use operations. The interpretable code may comprise different sets of code of different computer-interpretable languages (e.g., XQuery code 104, JavaScript code 108). For instance, different languages may be implemented within a same client-specific dataset to facilitate different types of operations (e.g., one language for server-side operations/definitions, and another language for client-side operations/definitions). As another example, FIG. 3 depicts an example representation of a client-specific dataset 302, which may include interpretable code in the form of markup language(s) 304 and/or programming language(s) 306. Markup language(s) 304 may be implemented to define preferences related to the presentation and/or structure of information (e.g., within a template, document, interactable form, etc.). Programming language(s) 306 may be implemented to define executable commands, such as logic, computation, and/or other tasks. Example markup language(s) 304 include XML, HTML, CSS, and/or others (as indicated by the ellipsis). Example programming language(s) 306 include XQuery, SQL, Java, Javascript, JSON, C, C++, C#, PHP, Perl, VBScript, and/or others (as indicated by the ellipsis).

Although a client-specific dataset 302 (particularly when presented within a single developer tool) may allow clients to tailor various aspects of multiple end use operations using multiple computer-interpretable languages, an information structure that includes multiple languages with intermixed structural components (e.g., indicated by markup languages 304), logic/commands (e.g., indicated by programming language(s) 306), and underlying content (e.g., legal statements in an estate planning instrument) can be difficult to test for well-formedness, validate, and/or accurately update.

Accordingly, in some embodiments, a system generates a homoiconic representation 310 of a client-specific dataset 302, as depicted in FIG. 3. The homoiconic representation 310 of the client-specific dataset 302 uses a single syntax to represent the structural components(s) 312, content component(s) 314, and logic component(s) 316 based upon the client preferences indicated in the client-specific dataset 302.

As used herein, a “content component” comprises a collection of code or characters that defines (or is configured to retrieve) information that becomes presented to end users when processed by a system (e.g., by recursive descent transform and execution of the output thereof, as will be described in more detail hereinafter). A “structural component” comprises a collection of code or characters configured to set or define the presentation to end users of information defined or retrieved via a content component when processed by a system (e.g., by recursive descent transform and execution of the output thereof, as will be described in more detail hereinafter). A “logical component” comprises a collection of code or characters configured to cause performance of one or more computations, logical operations, and/or any other programming task or command when processed by a system (e.g., by recursive descent transform and execution of the output thereof, as will be described in more detail hereinafter). Logical components may be associated with content components and/or structural components. For example, one or more logical components may be utilized to determine the particular content and/or structure defined by content components and/or logical components.

A system may generate the homoiconic representation 310 using parser(s) 308 to perform parse operations to output different subsets or portions of the homoiconic representation. For instance, a plurality of language-specific parsers may be defined for different coding languages that may be included in the client-specific dataset 302. Each language-specific parser may parse through the client-specific dataset 302 for code that corresponds to the particular language associated with the language-specific parser. The language-specific parser may then utilize the corresponding code as input to generate output code that utilizes a single syntax that matches an output syntax for all other language-specific parsers. In some instances, the single syntax differs from syntaxes associated with the coding languages of the client-specific dataset. The outputs of the various language-specific parsers may form different subsets or subsections of the code represented in the homoiconic representation 310.

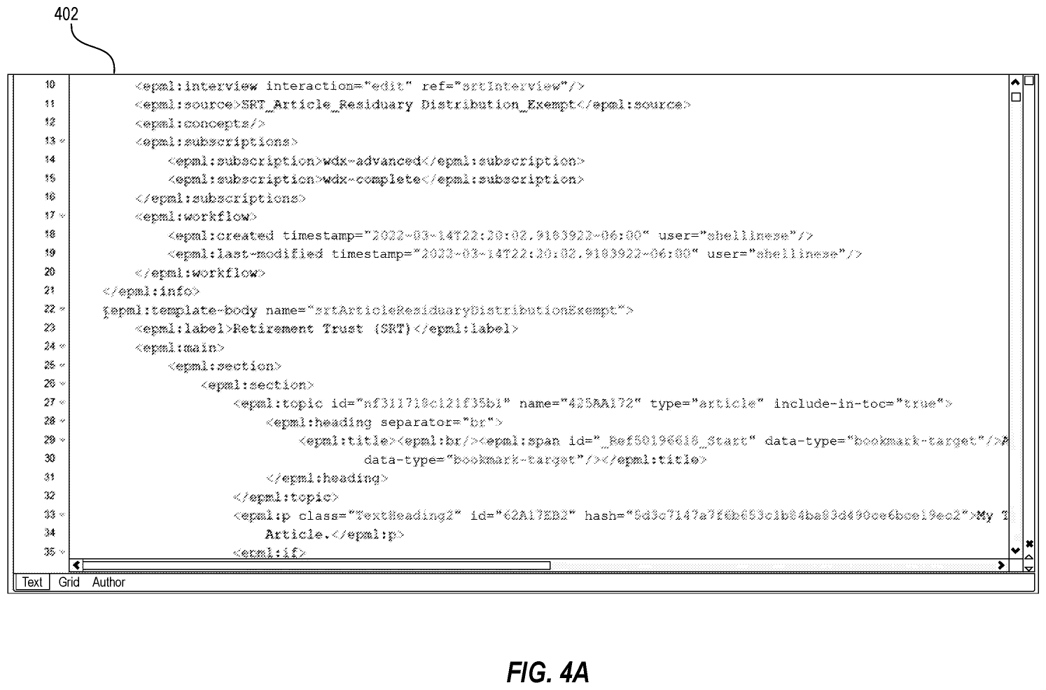

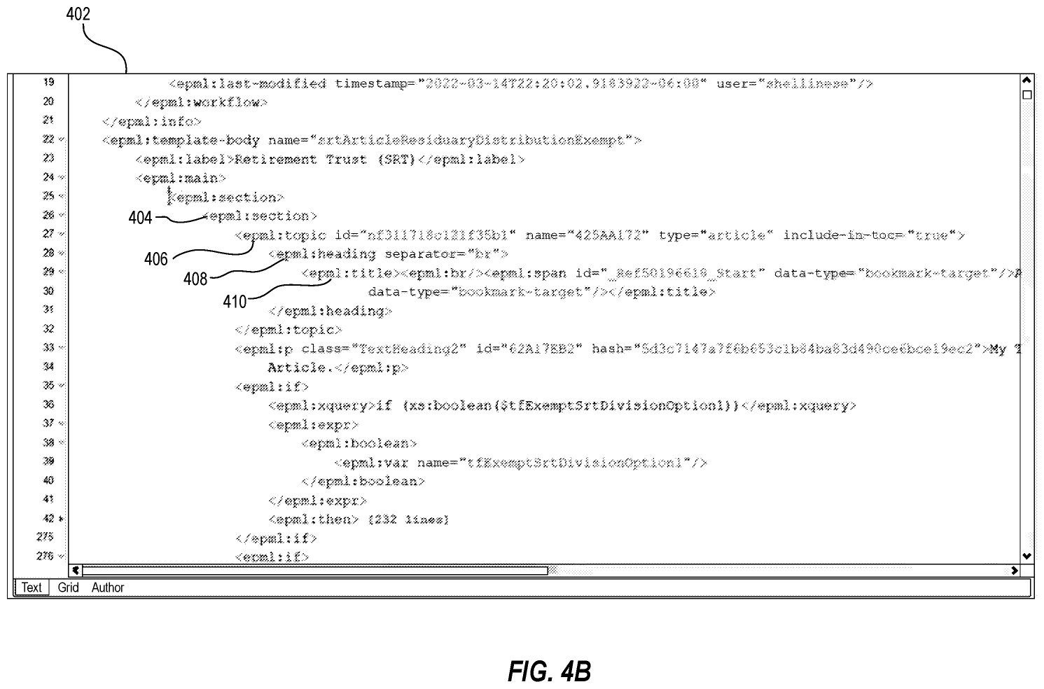

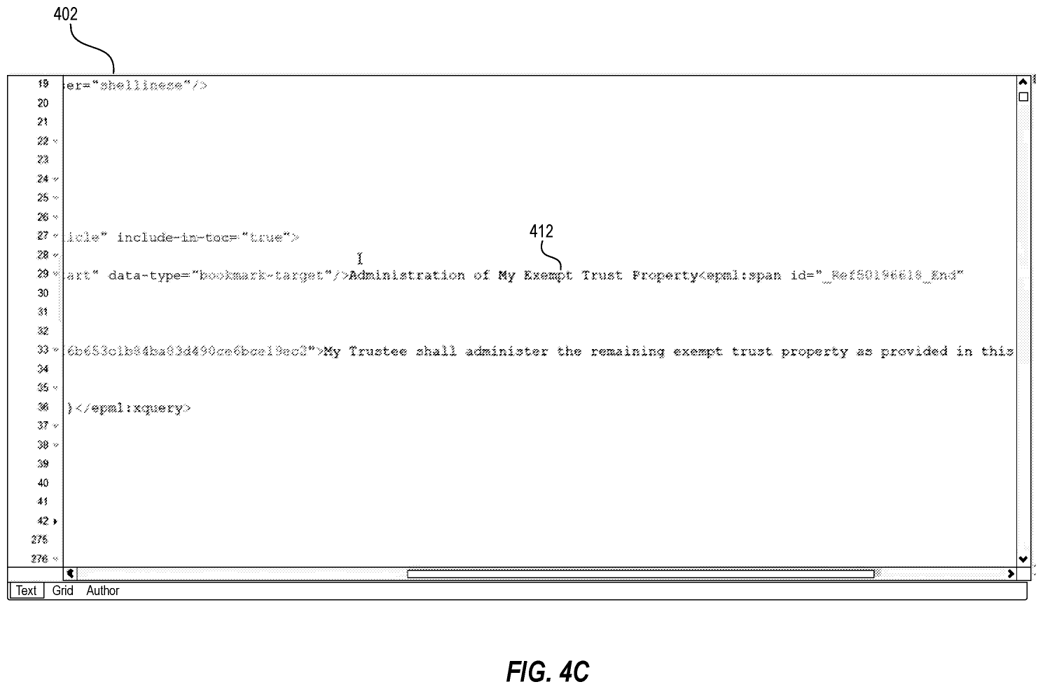

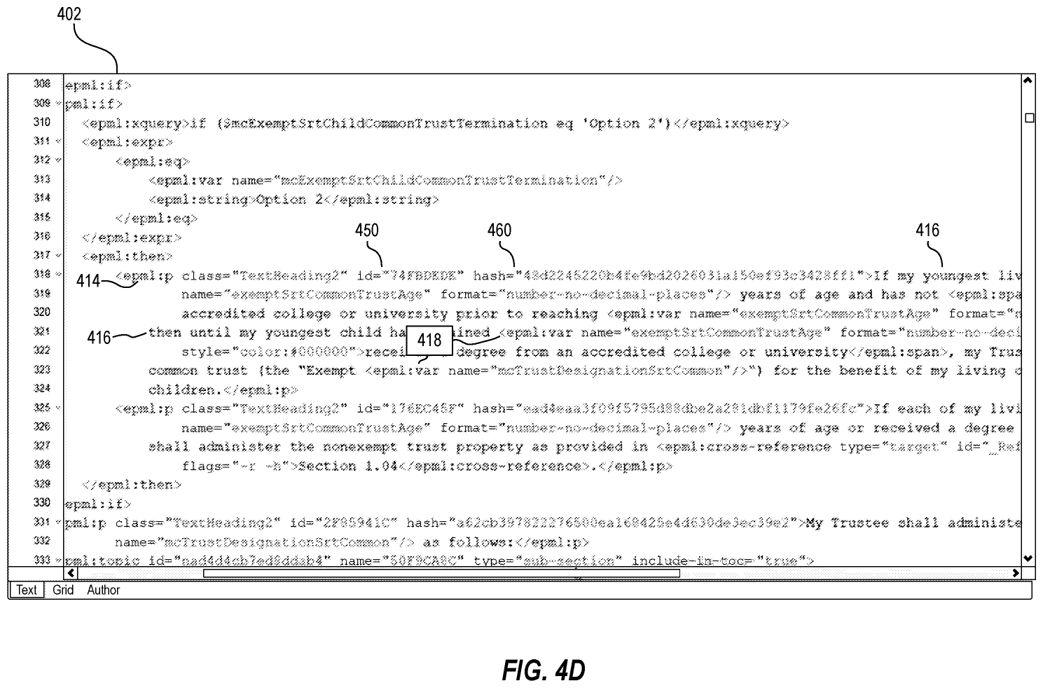

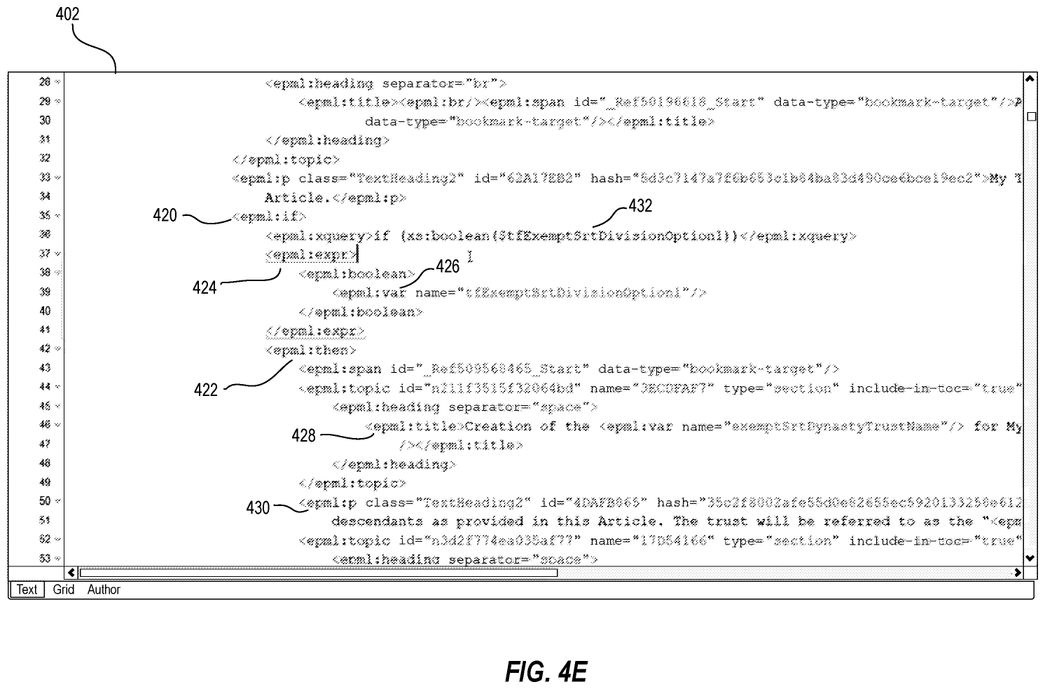

FIG. 4A illustrates an example homoiconic representation 402 of a client-specific dataset (e.g., corresponding to homoiconic representation 310 of client-specific dataset 302, as described with reference to FIG. 3). The homoiconic representation 402 may be regarded as a set of instructions for facilitating generation of output documents, forms, templates, etc. based upon the client-specific dataset that predicates the homoiconic representation 402 (e.g., via recursive descent transform and execution of the output thereof, as will be described in more detail hereinafter). As noted above, the homoiconic representation 402 includes a single syntax for depicting structural components, content components, and logical components, all of which may be interpreted to generate outputs (e.g., runtime interpretable code for generating documents, templates, interactable forms, etc.). The homoiconic representation 402 of FIG. 4A is provided in the paradigm of a markup language (i.e., XML), but other types of computer-interpretable languages may be used in accordance with the present disclosure.

As is evident from the example of FIG. 4A, the single syntax utilized to depict the various components of the homoiconic representation 402 implements tags with common characters or symbols (i.e., “epml”) that are shared for different types of components within the homoiconic representation 402. For instance, structural components, content components, and logical components represented within the homoiconic representation 402 all include “epml” as part the tag therefor. One will appreciate, in view of the present disclosure, that the principles disclosed herein may be implemented without the imposition of such a convention for tags for different types of components of a homoiconic representation.

FIG. 4B illustrates an example of structural components (e.g., structural component(s) 312) depicted in the homoiconic representation 402. For instance, structural components shown in FIG. 4B include sections 404 (“epml:section”), topics 406 (“epml:topic”). In the example provided in FIG. 4B, the sections 404 contain structural information pertaining to headers, footers, page margins, etc. The topics 406 may comprise a heading 408, which may comprise a title 410. Topics 406 may implement logical components (e.g., logic component(s) 316) that are interpretable to cause runtime determination of dynamic aspects of a document/form structure, such as nesting and/or numbering of articles, sections, subsections, pages, etc.).

The title 410 of a topic 406 may be regarded as a content component (e.g., content component(s) 314) and may comprise one or more strings of text. For instance, FIG. 4C shows that the title 410 includes a string of text 412 (i.e., “Administration of My Exempt Trust Property”). In some instances, text/characters of a title is/are configured to be determined by reference to a database entry (e.g., relying on one or more logic component(s) 316).

FIG. 4D illustrates another example of a content component of the homoiconic representation 402. In particular, FIG. 4D illustrates a paragraph 414 (“epml:p”), which may include various runtime manipulations/definitions (e.g., class, id, hash, etc.) and may include a strings of text 416 and/or variable calls 418 (“epml:var”) for causing acquisition/determination of content for presentation at runtime.

FIG. 4E illustrates an example of logic components (e.g., logic component(s) 316) depicted in the homoiconic representation 402. In particular, FIG. 4E shows an example if condition 420 configured to determine output content 422 (following “epml:then”) based upon whether an expression 424 (following “epml:expr”) of a Boolean variable is true. FIG. 4E shows that the expression 424 includes a variable call 426, indicating that logic components of a homoiconic representation 402 may depend upon data in memory and/or within a database. FIG. 4E illustrates the output content 422 as including a title 428 and a paragraph 430. Thus, in some instances, logical components may determine the content of content components within a homoiconic representation 402.

FIG. 4E furthermore illustrates a code expression 432 that is statically implemented into the homoiconic representation 402 as a string of text. In some implementations, the code expression 432 may be saved into the homoiconic representation 402 pursuant to the parse operations performed by the parser(s) 308 using the client-specific dataset 302 to generate the homoiconic representation 402. In this regard, a homoiconic representation 402 may include one or more strings of code with a syntax associated with one or more of the input languages represented in the client-specific database (e.g., XQuery, JavaScript, etc.), where such syntax differs from the single syntax of the homoiconic representation 402 for depicting structure components, content components, and logic components. Such strings of text may then be ready for execution/interpretation when the homoiconic representation 402 is used to generate a runtime representation (e.g., via recursive descent transform, as will be described in more detail hereinafter).

A homoiconic representation 402 may be stored on one or more servers (e.g., as a cloud service) to enable the homoiconic representation 402 to be readily accessed responsive to client requests. As noted above, a homoiconic representation 402 may prove easier to test for well-formedness and/or update (e.g., by a central entity) than the client-specific database that underlies the homoiconic representation 402.

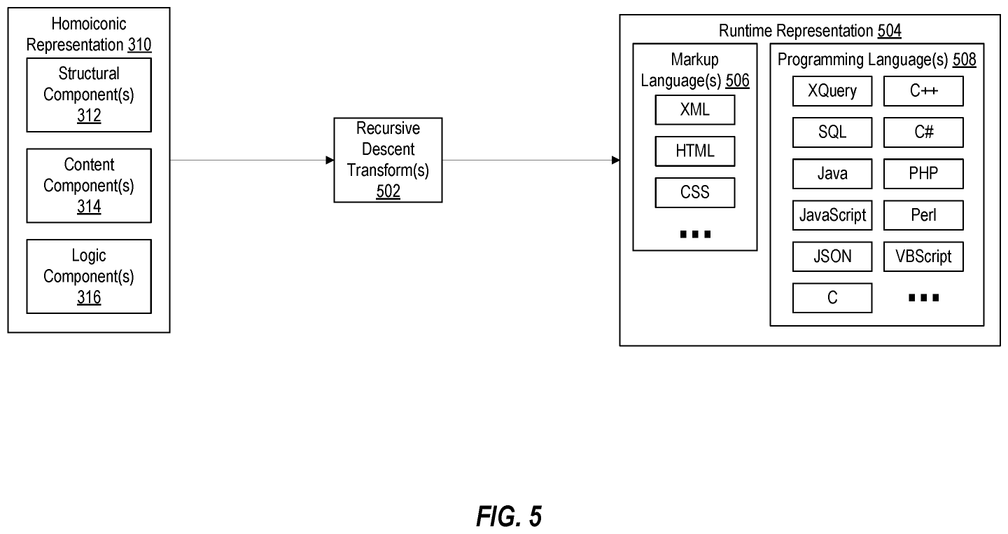

As noted above, a system may utilize a homoiconic representation of a client-specific dataset to generate a runtime interpretable representation of the client-specific dataset that is interpretable within a runtime environment to facilitate one or more end use operations (e.g., generation of dynamic documents, templates, interactable forms, etc.). FIG. 5 illustrates the homoiconic representation 310 of FIG. 3 and depicts recursive descent transform(s) 502 operating on the homoiconic representation 310 to generate a runtime representation 504. The runtime representation corresponds, in at least some respects, to the client-specific dataset discussed hereinabove. For example, the runtime representation 504 may comprise multiple coding languages (e.g., at least two languages), such as markup language(s) 506 and/or programming language(s) 508 in formats that are readily interpretable in a runtime environment (e.g., a testing environment, a production environment).

The runtime representation 504 may include any languages required by the runtime environment into which the runtime representation 504 will be utilized. The runtime representation 504 may thus be deployed for use by clients to facilitate the end use operations represented in client-specific dataset and the homoiconic representation 310 (e.g., similar in at least some respects to those shown and described with reference to FIG. 2B). For instance, the runtime representation 504 may be executed/interpreted within a runtime environment to cause performance of a template or document generation operation (e.g., to generate an estate planning document or template) and/or to cause performance of a user input acquisition operation (e.g., to present an interactable form for receiving information related to a person's estate plan for generating the estate planning document or template).

As indicated above, generating the runtime representation 504 may include performing recursive descent transform(s) 502 using the homoiconic representation 310. The single syntax of the homoiconic representation 310 (e.g., as described hereinabove with reference to FIGS. 4A through 4E) may contribute to a usability of the homoiconic representation 310 as input to the recursive descent transform(s) 502 to generate the runtime representation 504.

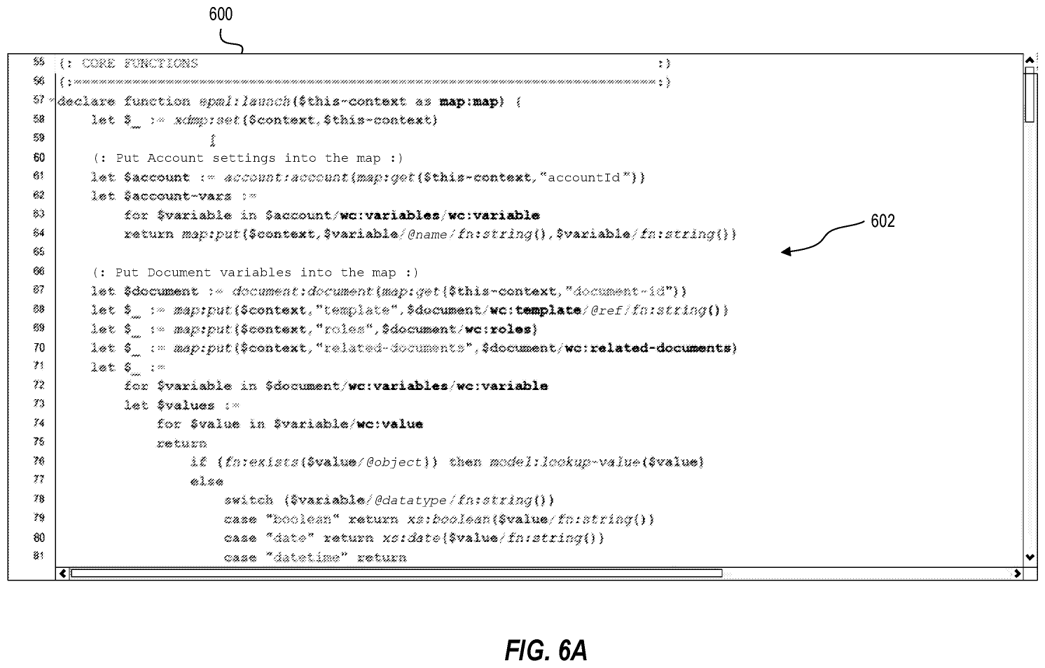

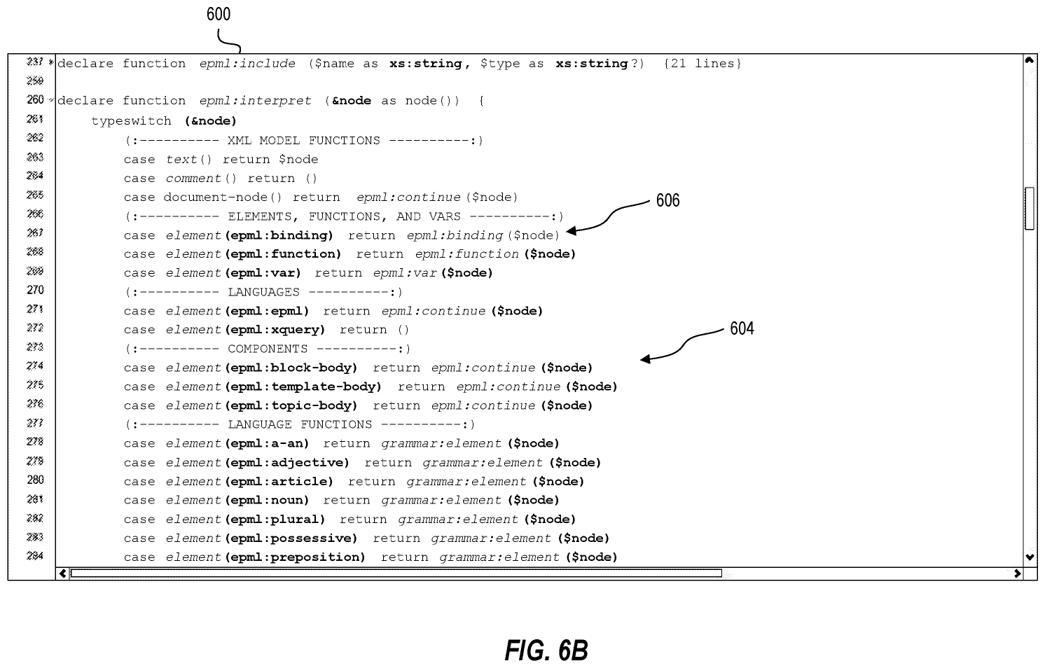

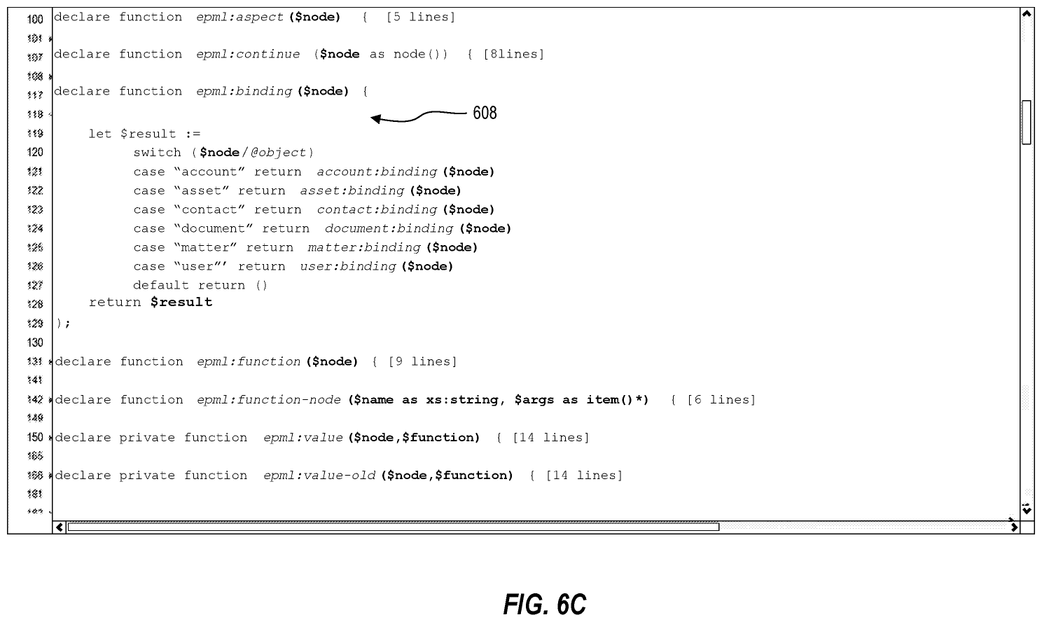

FIGS. 6A, 6B, and 6C illustrate example operations associated with a recursive descent transform(s) 502. In particular, FIGS. 6A, 6B, and 6B illustrate executable code 600 (in XQuery format) that is executable to transform the homoiconic representation 310 into the runtime representation 504. FIG. 6A illustrates an initialization portion 602 of the executable code 600 configured to define the in-memory variables and/or context for the transformation of the homoiconic representation 310 into the runtime representation 504.

FIG. 6B illustrates an interpretation portion 604 that defines code content to return responsive to detecting cases of particular elements corresponding to different components within the homoiconic representation 310. A system may utilize the interpretation portion 604 to recursively process various lines of code of the homoiconic representation 310 (e.g., beginning at a predefined entry or launch point) to return appropriate code content responsive to detecting instances of corresponding elements within the homoiconic representation 310. For instance, the interpretation portion 604 of FIG. 6B includes instructions 606 to detect instances of “epml:binding” within the homoiconic representation 310 and, responsive to detecting such instances, return code content related to “epml:binding” as defined in association with the executable code 600 (e.g., as defined within the executable code 600 and/or elsewhere).

FIG. 6C depicts a portion 608 of the executable code 600 that defines code content to return for “epml:binding” when detected within the homoiconic representation 310. For instance, FIG. 6C illustrates that different content may be returned depending upon the context of the binding function as represented in the homoiconic representation 310. For example, the portion 608 of the executable code 600 indicates to return “account:binding” when “account” is detected as context for “epml:binding”, whereas the portion 608 of the executable code 600 indicates to return “asset:binding” when “asset” is detected as context for “epml:binding”. The particular code content associated with “account:binding” and “asset:binding” may be defined elsewhere within the executable code 600 (or within another data structure).

The executable code 600 may comprise other definitions of code content to return responsive to detecting instances of particular elements within a homoiconic representation. The executable code 600 may be configured to return code content of different languages (e.g., at least two different languages), depending on the runtime environment. A system may thus perform recursive descent transform(s) 502 to generate a runtime representation 504 of the homoiconic representation 310 that is interpretable/executable within a runtime environment (e.g., a developer environment, a testing environment, a production environment) to facilitate end use operations (e.g., template generation, user input acquisition, etc.). In some instances, different recursive descent transform operations may be performed to output code of different languages to generate different runtime representations for different runtime environments.

### Techniques for Facilitating Modifications and Updates to Shared Content

A homoiconic representation comprises a language-agnostic body of code that, as noted above, can enable easier testing for well-formedness and/or updating. In some instances, a central entity that provides multiple clients with developer tools for facilitating template/form generation (e.g., as discussed above) updates information associated with the generation of templates and/or forms. For example, a central entity may update or remove one or more bodies of text (e.g., that are present in homoiconic representations associated with client datasets) that existed in template/form versions that were previously provided to clients. Such updates may occur for various reasons, such as changes in laws/regulations/best practices, etc. Furthermore, in some instances, clients may have made independent modifications to bodies of text that were also updated by the central entity. At least some disclosed embodiments are directed to detecting instances where client modifications and central updates have occurred to the same set of information, thereby enabling clients to ensure that their modifications accord with the updates.

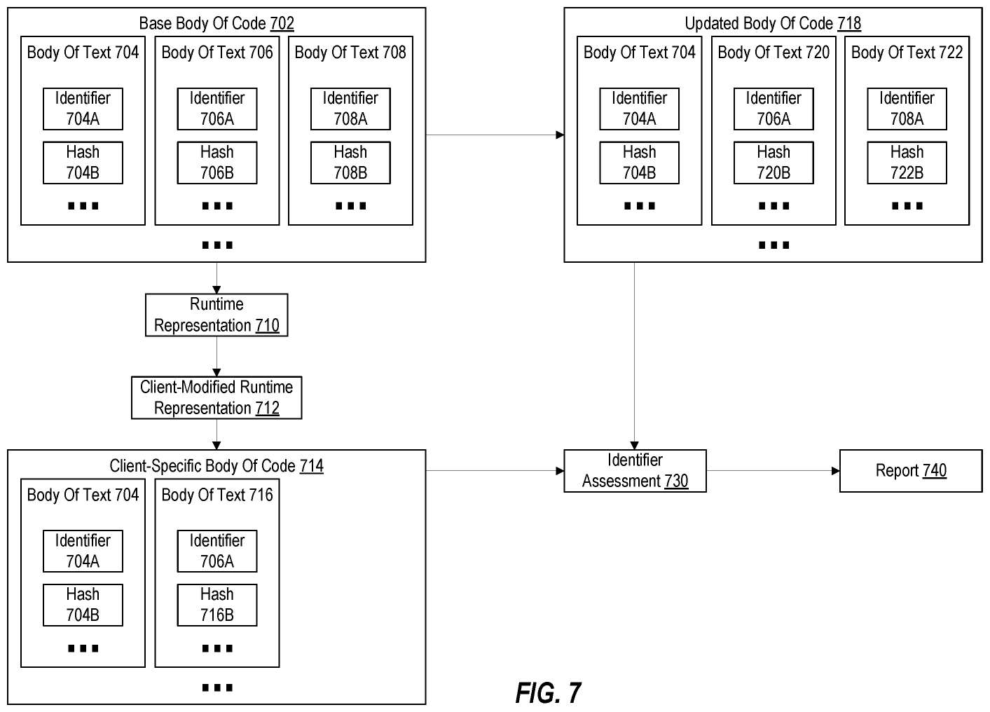

FIG. 7 illustrates a conceptual depiction of generating a report 740 based upon updates and client modifications to a base body of code 702. The base body of code 702 comprises code components that form the basis for generating homoiconic representations of client-specific datasets. For example, the base body of code 702 may comprise default code elements that the parser(s) 308 are configured to output when interpreting a client-specific dataset 302 to generate a homoiconic representation 310. In some instances, the base body of code 702 includes code elements that are represented within one or more homoiconic representations that are based upon client-specific datasets (e.g., form text/characters that are preserved by default when within a homoiconic representation based upon a client-specific dataset).

FIG. 7 illustrates the base body of code 702 as including various bodies of text (e.g., text and/or other characters), such as body of text 704, body of text 706, and body of text 708 (any number of bodies of text may be included, as indicated by the ellipsis). The bodies of text 704, 706, and 708 may comprise paragraphs, sentences, pages, and/or other separable groups of paragraphs/content. The example of FIG. 7 shows the bodies of text 704, 706, and 708 as including respective identifiers. Any number of respective identifiers may be utilized in association with bodies of text within a base body of code (as indicated by the ellipses). The example of FIG. 7 illustrates identifier 704A and hash 704B for body of text 704, identifier 706A and hash 706B for body of text 706, and identifier 708A and hash 708B for body of text 708. The hashes 704B, 706B, and 708B may comprise hash codes generated based upon the content of the bodies of text 704, 706, and 708, respectively.

The identifiers 704A, 706A, and/or 708A may take on any suitable form (e.g., universally or globally unique identifiers, and/or others). By way of illustrative example, paragraph 414 of the homoiconic representation 402 of FIG. 4B comprises a paragraph identification code 450 (labeled as id=“74FBDEDE”) which may correspond to the identifiers 704A, 706A, and 708A. The paragraph identification code 450 may thus be used to identify the presence of the bodies of text 704, 706, and 708 associated, respectively, therewith in view of client modifications and/or central updates to the base body of code 702.

As another illustrative example, paragraph 414 of the homoiconic representation 402 of FIG. 4B comprises a hash code 460 corresponding to hashes 704B, 706B, and 708B (labeled in FIG. 4D as hash=“48d2245220b4fe9bd2026031a150ef93c3428ff1). The hash code 460 is generated utilizing the content (e.g., strings of text) of the paragraph 414. The hashes 704B, 706B, and 708B may be used to detect changes made to corresponding bodies of text 704, 706, and 708 associated, respectively, therewith in view of client modifications and/or central updates to the base body of code 702.

In the example of FIG. 7, the base body of code 702 is utilized to provide a runtime representation 710, which may comprise interpretable/executable code for use in a runtime environment. The runtime representation 710 may be generated, for example, utilizing recursive descent transform as discussed hereinabove with reference to FIGS. 5 through 6C. A client may modify the runtime representation 710 to provide a client-modified runtime representation 712. For example, such client modifications may be generated within a client developer environment, such as by utilizing the developer tool discussed with reference to FIGS. 1A and 1B. The client-modified runtime representation 712 may correspond to a client-specific dataset as described hereinabove with reference to FIGS. 1A through 3.

The client modifications to the runtime representation 710 to provide the client-modified runtime representation 712 may effectuate modification to one or more of the bodies of text 704, 706, and/or 708 originally present within the base body of code 702. For instance, based upon the client-modified runtime representation 712 (or client-specific dataset), a system may generate a client-specific body of code 714 (e.g., via parser(s) 308). The client-specific body of code 714 of FIG. 7 includes body of text 704 and its associated identifier 704A and hash 704B. However, the client-specific body of code 714 includes body of text 716, which shares the same identifier 706A as body of text 706 but includes a different hash 716B than hash 706B associated with body of text 706 (different than hash 706B).

The identifier 706A being preserved in body of text 716 of the client-specific body of code 714 indicates that body of text 716 corresponds in at least some respects to body of text 706 of the base body of code 702. For example, bodies of text 706 and 716 may comprise identical relative or ordinal placement within the base body of code 702 and the client-specific body of code 714, respectively. In contrast, FIG. 7 shows that the client-specific body of code 714 omits a body of text that includes an identifier that matches identifier 706A of body of text 708 of the base body of code 702. The absence of an identifier that corresponds to identifier 706A of body of text 708 indicates that the client modifications to the base body of code 702 (e.g., caused by the client modifications to the runtime representation 710) caused deletion of the body of text 708 from the client-specific body of code 714 (as well as deletion of the identifier 708A and the hash 708B from the client-specific body of code 714).

As noted above, the hash 716B associated with body of text 716 is different than the hash 706B associated with body of text 706, indicating that body of text 716 of the client-specific body of code 714 includes at least one change in content relative to body of text 706 of the base body of code 702. For example, the client modifications to the runtime representation 710 may cause modifications to a string of text for a paragraph originally represented in the base body of code 702. In other instances, client modifications causing generation of a client-specific body of code 714 are made directly to a base body of code 702 to generate a client-specific body of code 714 that includes one or more paragraphs with different content than corresponding paragraphs in the base body of code 702. Such direct modifications may be constrained by a predefined schema to facilitate real-time validation of modifications to the base body of code 702.

In some instances, client modifications are permitted to a base body of code 702 to allow clients to tailor default content to their own needs and/or preferences. However, changes to the base body of code 702 may independently be performed by a central or other entity to update the same default content, which may give rise to conflicts between client modifications and central updates.

For example, FIG. 7 shows an updated body of code 718, which includes body of text 704, body of text 720, and body of text 722. The bodies of text 704, 720, and 722 of the updated body of code 718 may be generated based upon updates to the base body of code 702 (e.g., updates performed by a central entity). Body of text 704 in the updated body of code 718 is unchanged relative to its representation in the base body of code 702, as indicated in FIG. 7 by body of text 704 comprising identical identifiers and hashes in the updated body of code 718 and the base body of code 702. Similar to body of text 716 of the client-specific body of code 714, body of text 720 of the updated body of code 718 comprises the same identifier 706A as body of text 706 of the base body of code 702. However, body of text 720 comprises a different hash 720B than the hash 706B associated with body of text 706 of the base body of code 702, indicating that bodies of text 720 and 706 comprise at least slightly different content. Body of text 722 similarly includes the same identifier 708A as the corresponding body of text 708 in the base body of code 702, but comprises a different hash 722B than the hash 708B of the corresponding body of text 708 in the base body of code 702 (also indicating that bodies of text 722 and 708 comprise at least slightly different content).

In some instances, clients may desire to be informed when updates to a base body of code (e.g., represented in the updated body of code 718) conflict with their own modifications to the base body of code (e.g., represented in the client-specific body of code 714). For instance, updates made to a base body of code may be performed in response to changes in underlying law, regulations, best practices, etc. Accordingly, FIG. 7 illustrates an identifier assessment 730 that a system may perform to determine whether client modifications affect bodies of text that were also independently updated. For example, an identifier assessment 730 may include determining that one or more bodies of text that were present in the base body of code 702 (i) have been deleted from the client-specific body of code 714 and (ii) were updated in the updated body of code 718 (e.g., body of text 708). Such an identifier assessment 730 may comprise determining which identifiers that are/were present in the updated body of code 718 and/or the base body of code 702 (i) have become absent from the client-specific body of code 714 (e.g., identifier 708A) and (ii) are associated with bodies of text in the updated body of code 718 that comprise different content than corresponding bodies of text in the base body of code 702 (e.g., based upon differences in hashes 722B and 708B).

In response to determining that the updated body of code 718 includes one or more bodies of text that were updated in the updated body of code 718 and are absent from the client-specific body of code 714, a system may generate a report 740 and provide the report to one or more appropriate entities (e.g., the client, the central entity, etc.). For example, the report may comprise a client notification indicating that an update occurred to at least some bodies of text of the base body of code 702 that the client deleted. Additionally, or alternatively, the report may prompt the client to review the updated content. In the example of FIG. 7, a report may indicate that the client-specific body of code 714 omits a body of text 708 that was updated in accordance with body of text 722.

In some instances, an identifier assessment 730 may be regarded as determining an intersection between two sets of bodies of text (e.g., determining bodies of text that are included in both sets). For example, an identifier assessment 730 may comprise determining an intersection between (i) a set of bodies of text of the base body of code 702 that were updated according to the updated body of code 718 and (ii) a set of bodies of text of the base body of code that were modified according to the client-specific body of code 714. The intersection may be determined utilizing the identifiers associated with the bodies of text. For instance, the identifier assessment 730 may comprise determining an intersection between (i) a set of identifiers of the base body of code 702 that became updated in the updated body of code 718 (e.g., hashes 706B and 708B updated to hashes 720B and 722B, respectively) and (ii) a set of identifiers of the base body of code 702 that became modified in the client-specific body of code 714 (e.g., hash 706B modified to hash 716B, and/or hash 708B becoming deleted). In the example of FIG. 7, such an intersection may include hashes 706B and/or 708B.

The report 740 may include an indication of the bodies of text that were updated according to the updated body of code 718 and that were modified in and/or are absent from the client-specific body of code 714 (e.g., bodies of text 706 and/or 708, in the example of FIG. 7). Additionally, or alternatively, the report 740 may prompt the client to review the updates to such bodies of text.

### Example Methods

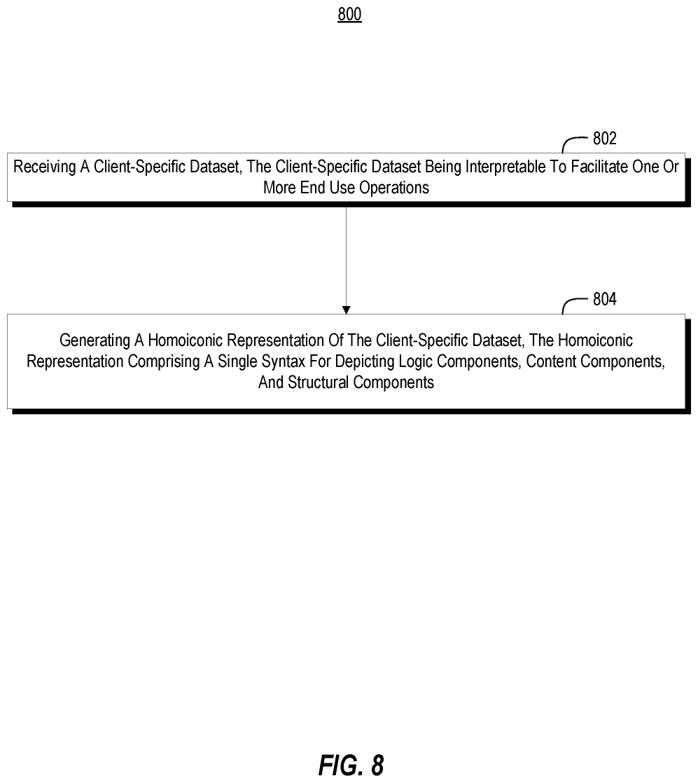

Some implementations of the present disclosure can be described in terms of acts (e.g., acts of a method) for accomplishing one or more particular results. Along these lines, FIGS. 8 through 11 illustrate example flow diagrams depicting various acts associated with the disclosed embodiments. Although the acts shown in the flow diagrams may be illustrated and/or discussed in a certain order, no particular ordering is required unless specifically stated, or required because an act is dependent on another act being completed prior to the act being performed. Furthermore, it should be noted that not all acts represented in the flow diagrams are necessarily essential for implementing the disclosed embodiments.

FIG. 8 illustrates an example flow diagram 800 depicting acts associated with generating a homoiconic representation of a client-specific dataset, in accordance with implementations of the present disclosure.

Act 802 of flow diagram 800 includes receiving a client-specific dataset, the client-specific dataset being interpretable to facilitate one or more end use operations. The client-specific dataset may comprise at least a first set of interpretable code and a second set of interpretable code. The first set of interpretable code may comprise one or more first computer-interpretable languages, and the second set of interpretable code may comprise one or more second computer-interpretable languages that are different from the one or more first computer-interpretable languages. The one or more first computer-interpretable languages may comprise one or more markup languages, and the one or more second computer-interpretable languages may comprise one or more programming languages. In some instances, the homoiconic representation represents structure associated with the one or more markup languages and commands associated with the one or more programming languages with the single syntax. The one or more end use operations may comprise at least a user input acquisition operation and a template generation operation. The client-specific dataset may comprise one or more client-defined preferences related to end use functionality of the user input acquisition operation and the template generation operation. In some instances, the one or more client-defined preferences are defined according to a predefined schema.

Act 804 of flow diagram 800 includes generating a homoiconic representation of the client-specific dataset, the homoiconic representation comprising a single syntax for depicting logic components, content components, and structural components. The single syntax may be different than syntaxes associated with the one or more first computer-interpretable languages and the one or more second computer-interpretable languages. The homoiconic representation may be generated by performing a first set of parse operations on the first set of interpretable code to generate a first subset of the homoiconic representation, and performing a second set of parse operations on the second set of interpretable code to generate a second subset of the homoiconic representation. In some instances, the single syntax for depicting the logic components, the content components, and the structural components contributes to a usability of the homoiconic representation as input to generate a runtime representation that is interpretable to facilitate the one or more end use operations.

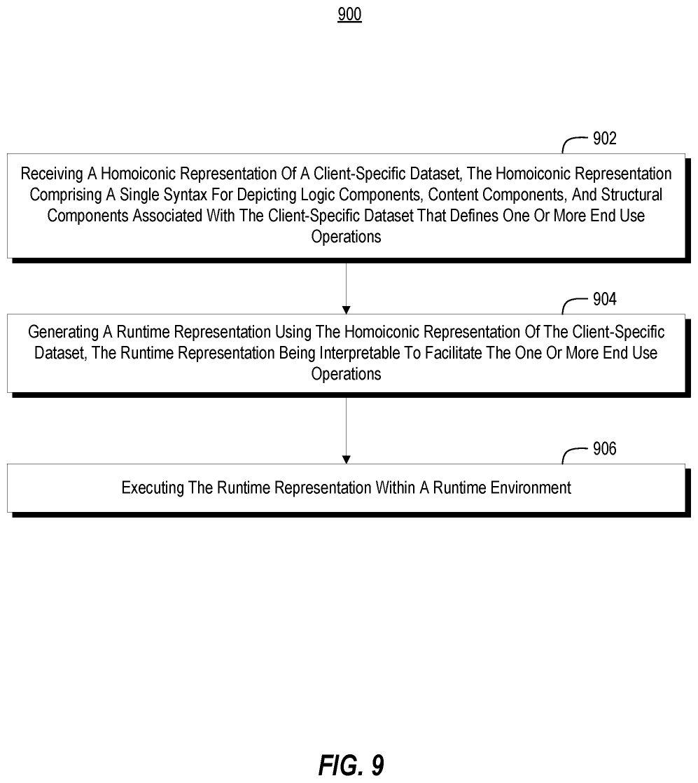

FIG. 9 illustrates an example flow diagram 900 depicting acts associated with generating a runtime representation of a homoiconic representation of a client-specific dataset.

Act 902 of flow diagram 900 includes receiving a homoiconic representation of a client-specific dataset, the homoiconic representation comprising a single syntax for depicting logic components, content components, and structural components associated with the client-specific dataset that defines one or more end use operations. In some instances, the one or more end use operations comprise at least a user input acquisition operation and a template generation operation. The client-specific dataset may comprise one or more client-defined preferences related to end use functionality of the user input acquisition operation and the template generation operation. The one or more client-defined preferences may be defined according to a predefined schema. End use functionality of the user input acquisition operation can be constrained by a predefined data model.

Act 904 of flow diagram 900 includes generating a runtime representation using the homoiconic representation of the client-specific dataset, the runtime representation being interpretable to facilitate the one or more end use operations. The runtime representation may comprise at least a first set of interpretable code and a second set of interpretable code. The first set of interpretable code may comprise one or more first computer-interpretable languages, and the second set of interpretable code may comprise one or more second computer-interpretable languages that are different from the one or more first computer-interpretable languages. Syntaxes associated with the one or more first computer-interpretable languages and the one or more second computer-interpretable languages may be different than the single syntax. The one or more first computer-interpretable languages may comprise one or more markup languages, and the one or more second computer-interpretable languages may comprise one or more programming languages. The homoiconic representation may represent structure associated with the one or more markup languages and commands associated with the one or more programming languages with the single syntax. Generating the runtime representation may comprise performing a recursive descent transform operation using the homoiconic representation as input. The single syntax for depicting the logic components, the content components, and the structural components may contribute to a usability of the homoiconic representation as input to the recursive descent transform operation to generate the runtime representation.

Act 906 of flow diagram 900 includes executing the runtime representation within a runtime environment. Execution of the runtime representation within the runtime environment causes performance of the user input acquisition operation or the template generation operation.

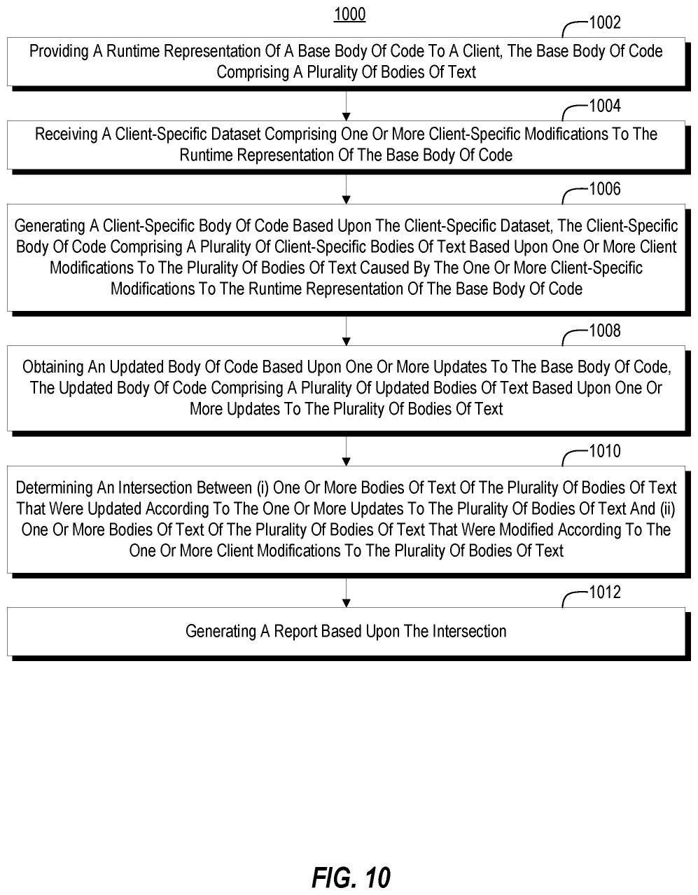

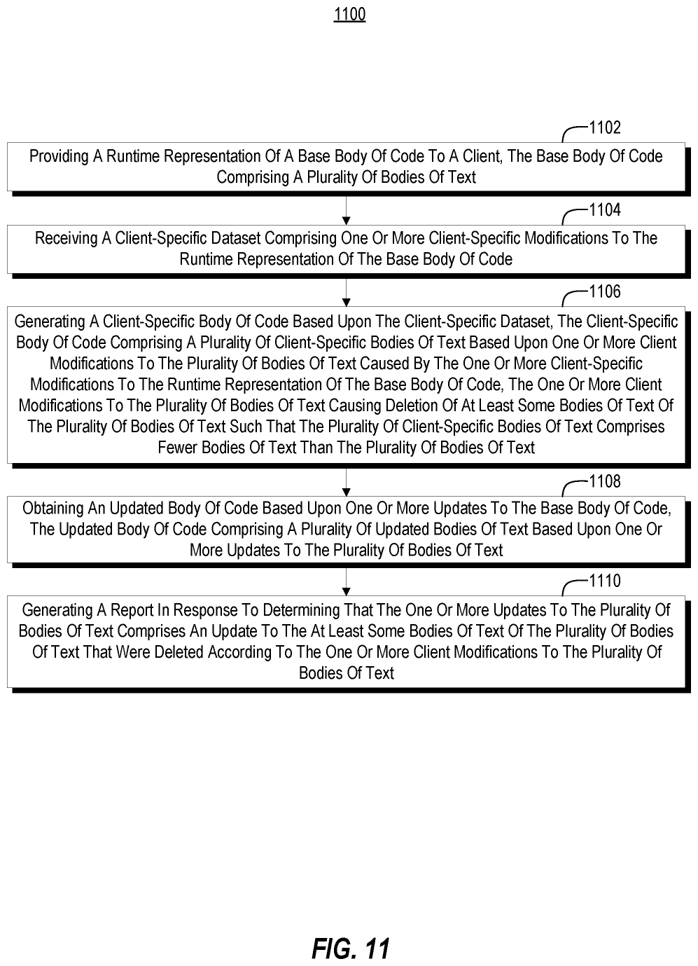

FIGS. 10 and 11 illustrate example flow diagrams 1000 and 1100, respectively, depicting acts associated with generating reports based upon updates and client modifications to a base body of code, in accordance with implementations of the present disclosure.

Act 1002 of flow diagram 1000 includes providing a runtime representation of a base body of code to a client, the base body of code comprising a plurality of bodies of text. The base body of code may comprise a set of respective identifiers. The set of respective identifiers may comprise a respective identifier for each of the plurality of bodies of text. Each respective identifier of the set of respective identifiers may comprise a respective predefined paragraph identification code. Each respective identifier of the set of respective identifiers may additionally or alternatively comprise a hash code generated based upon content of a respective body of text of the plurality of bodies of text.

Act 1004 of flow diagram 1000 includes receiving a client-specific dataset comprising one or more client-specific modifications to the runtime representation of the base body of code.

Act 1006 of flow diagram 1000 includes generating a client-specific body of code based upon the client-specific dataset, the client-specific body of code comprising a plurality of client-specific bodies of text based upon one or more client modifications to the plurality of bodies of text caused by the one or more client-specific modifications to the runtime representation of the base body of code. The one or more client modifications to the plurality of bodies of text may cause modification of at least some respective identifiers of the set of respective identifiers to generate a set of client-modified respective identifiers. The set of client-modified respective identifiers may be represented within the client-specific body of code.

Act 1008 of flow diagram 1000 includes obtaining an updated body of code based upon one or more updates to the base body of code, the updated body of code comprising a plurality of updated bodies of text based upon one or more updates to the plurality of bodies of text. The one or more updates to the plurality of bodies of text may cause updating of at least some respective identifiers of the set of respective identifiers to generate a set of updated respective identifiers. The set of updated respective identifiers may be represented within the updated body of code.

Act 1010 of flow diagram 1000 includes determining an intersection between (i) one or more bodies of text of the plurality of bodies of text that were updated according to the one or more updates to the plurality of bodies of text and (ii) one or more bodies of text of the plurality of bodies of text that were modified according to the one or more client modifications to the plurality of bodies of text. In some instances, determining the intersection comprises determining an intersection between (i) one or more respective identifiers of the set of respective identifiers that become updated to generate the set of updated respective identifiers and (ii) one or more respective identifiers of the set of respective identifiers that become modified to generate the set of client-modified respective identifiers.

Act 1012 of flow diagram 1000 includes generating a report based upon the intersection. The report may comprise a client notification provided to the client. The client notification may indicate the one or more bodies of text that were modified according to the one or more client modifications and that were updated according to the one or more updates. The report may prompt the client to review the one or more bodies of text that were modified according to the one or more client modifications and that were updated according to the one or more updates. The base body of code, the client-specific body of code, or the updated body of code may comprise a homoiconic representation of code that comprises a single syntax for depicting logic components, content components, and structural components.

Act 1102 of flow diagram 1100 includes providing a runtime representation of a base body of code to a client, the base body of code comprising a plurality of bodies of text. The base body of code may comprise a set of respective identifiers. The set of respective identifiers may comprise a respective identifier for each of the plurality of bodies of text. Each respective identifier of the set of respective identifiers may comprise a respective predefined paragraph identification code.

Act 1104 of flow diagram 1100 includes receiving a client-specific dataset comprising one or more client-specific modifications to the runtime representation of the base body of code.

Act 1106 of flow diagram 1100 includes generating a client-specific body of code based upon the client-specific dataset, the client-specific body of code comprising a plurality of client-specific bodies of text based upon one or more client modifications to the plurality of bodies of text caused by the one or more client-specific modifications to the runtime representation of the base body of code, the one or more client modifications to the plurality of bodies of text causing deletion of at least some bodies of text of the plurality of bodies of text such that the plurality of client-specific bodies of text comprises fewer bodies of text than the plurality of bodies of text. The one or more client modifications to the plurality of bodies of text may cause deletion of at least some respective identifiers of the set of respective identifiers to generate a set of client-modified respective identifiers (the set of client-modified respective identifiers may be represented within the client-specific body of code).

Act 1108 of flow diagram 1100 includes obtaining an updated body of code based upon one or more updates to the base body of code, the updated body of code comprising a plurality of updated bodies of text based upon one or more updates to the plurality of bodies of text.

Act 1110 of flow diagram 1100 includes generating a report in response to determining that the one or more updates to the plurality of bodies of text comprises an update to the at least some bodies of text of the plurality of bodies of text that were deleted according to the one or more client modifications to the plurality of bodies of text. Determining that the one or more updates to the plurality of bodies of text comprises the update to the at least some bodies of text of the plurality of bodies of text that were deleted according to the one or more client modifications to the plurality of bodies of text may be based upon the set of client-modified respective identifiers. The report may comprise a client notification provided to the client. The client notification may indicate that the update occurred to the at least some bodies of text of the plurality of bodies of text that were deleted according to the one or more client modifications to the plurality of bodies of text. The report may prompt the client to review the update to the at least some bodies of text of the plurality of bodies of text. The base body of code, the client-specific body of code, or the updated body of code may comprise a homoiconic representation of code that comprises a single syntax for depicting logic components, content components, and structural components.

The embodiments disclosed herein may be practiced by a system (e.g., one or more computing systems) including one or more processors and computer-readable media (e.g., hardware storage devices) such as computer memory. Such components of a system may be associated with different devices that are interconnected (e.g., over a network). Computer memory may store computer-executable instructions that when executed by one or more processors cause various functions to be performed, such as the acts described herein.

Computing system functionality can be enhanced by a computing systems' ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing systems.

Interconnection of computing systems has facilitated distributed computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available.

Examples of software user interfaces include graphical user interfaces, text command line based user interface, function key or hot key user interfaces, and the like.

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The described embodiments are to be considered in all respects only as illustrative and not restrictive. All changes which come within the meaning and range of equivalency of the disclosure are to be embraced within their scope.

What is claimed is:

1. A system, comprising:
one or more processors; and
one or more hardware storage devices that store instructions that are executable by the one or more processors to configure the system to:
receive a client-specific dataset, the client-specific dataset being interpretable to facilitate one or more end use operations, the client-specific dataset comprising at least:
a first set of interpretable code, the first set of interpretable code comprising one or more first computer-interpretable languages; and
a second set of interpretable code, the second set of interpretable code comprising one or more second computer-interpretable languages that are different from the one or more first computer-interpretable languages; and
generate a homoiconic representation of the client-specific dataset, the homoiconic representation comprising a single syntax for depicting logic components, content components, and structural components, the single syntax being different than syntaxes associated with the one or more first computer-interpretable languages and the one or more second computer-interpretable languages.

2. The system of claim 1, wherein generating the homoiconic representation comprises:
performing a first set of parse operations on the first set of interpretable code to generate a first subset of the homoiconic representation; and
performing a second set of parse operations on the second set of interpretable code to generate a second subset of the homoiconic representation.

3. The system of claim 1, wherein the single syntax for depicting the logic components, the content components, and the structural components contributes to a usability of the homoiconic representation as input to generate a runtime representation that is interpretable to facilitate the one or more end use operations.

4. The system of claim 3, wherein the one or more end use operations comprise at least a user input acquisition operation and a template generation operation.

5. The system of claim 4, wherein the client-specific dataset comprises one or more client-defined preferences related to end use functionality of the user input acquisition operation and the template generation operation.

6. The system of claim 5, wherein the one or more client-defined preferences are defined according to a predefined schema.

7. The system of claim 1, wherein the one or more first computer-interpretable languages comprise one or more markup languages.

8. The system of claim 7, wherein the one or more second computer-interpretable languages comprise one or more programming languages.

9. The system of claim 8, wherein the homoiconic representation represents structure associated with the one or more markup languages and commands associated with the one or more programming languages with the single syntax.

10. A system, comprising:
one or more processors; and
one or more hardware storage devices that store instructions that are executable by the one or more processors to configure the system to:
receive a homoiconic representation of a client-specific dataset, the homoiconic representation comprising a single syntax for depicting logic components, content components, and structural components associated with the client-specific dataset that defines one or more end use operations; and
generate a runtime representation using the homoiconic representation of the client-specific dataset, the runtime representation being interpretable to facilitate the one or more end use operations, wherein the runtime representation comprises at least:
a first set of interpretable code, the first set of interpretable code comprising one or more first computer-interpretable languages; and
a second set of interpretable code, the second set of interpretable code comprising one or more second computer-interpretable languages that are different from the one or more first computer-interpretable languages, wherein syntaxes associated with the one or more first computer-interpretable languages and the one or more second computer-interpretable languages are different than the single syntax.

11. The system of claim 10, wherein generating the runtime representation comprises performing a recursive descent transform operation using the homoiconic representation as input.

12. The system of claim 11, wherein the single syntax for depicting the logic components, the content components, and the structural components contributes to a usability of the homoiconic representation as input to the recursive descent transform operation to generate the runtime representation.

13. The system of claim 10, wherein the one or more end use operations comprise at least a user input acquisition operation and a template generation operation.

14. The system of claim 13, wherein the client-specific dataset comprises one or more client-defined preferences related to end use functionality of the user input acquisition operation and the template generation operation.

15. The system of claim 14, wherein the one or more client-defined preferences are defined according to a predefined schema.

16. The system of claim 15, wherein end use functionality of the user input acquisition operation is constrained by a predefined data model.

17. The system of claim 16, wherein the instructions are executable by the one or more processors to further configure the system to:
execute the runtime representation within a runtime environment, wherein execution of the runtime representation within the runtime environment causes performance of the user input acquisition operation or the template generation operation.

18. The system of claim 1, wherein the one or more first computer-interpretable languages comprise one or more markup languages.

19. The system of claim 18, wherein the one or more second computer-interpretable languages comprise one or more programming languages.

20. The system of claim 19, wherein the homoiconic representation represents structure associated with the one or more markup languages and commands associated with the one or more programming languages with the single syntax.
